(19) United States
(12) Patent Application Publication
(10) Pub. No.: US 2010/0142193 A1
(43) Pub. Date: Jun. 10, 2010

(54) METHOD OF DISPLAYING DECORATIVE MATERIAL

(76) Inventor: Mark Andrew Stone, Belper (GB)

Correspondence Address: CHERNOFF, VILHAUER, MCCLUNG & STENZEL, LLP, 601 SW Second Avenue, Suite 1600, Portland, OR, 97204, US

(21) Appl. No.: 12/513,324

(22) PCT Filed: Nov. 2, 2007
(86) PCT No.: PCT/GB07/04190

§ 371 Date: Feb. 3, 2010

(30) Foreign Application Priority Data
Nov. 4, 2006 (GB) 0622003.2

(51) Int. Cl. F21V 33/00; F21S 8/08; F21L 4/00

(52) U.S. Cl. 362/154; 362/410; 362/183

(57) ABSTRACT

A decorative item 112 for mounting to a container 10 includes an electrical circuit 120 and a structure 122. The electrical circuit 120 is self contained and includes accumulation means 124, a light source 126, and a solar power connector 128. The structure 122 is arranged to support the light source 126. The item includes a mounting 130 for mounting to the container 10. The invention also provides a method of displaying decorative material which includes the steps of providing a container 10 defining an interior 20, locating a first seasonal decorative material in the interior 20, installing the container 10 in a public place, after a first predetermined time period, removing the first material and locating a second seasonal decorative material in the interior 20.

The present invention relates to a method of displaying decorative material. The invention also discloses a decorative item, particularly but not exclusively a decorative item for mounting in an interior of a container.

It is common for local authorities to provide planting displays during spring and summer months which include items such as hanging baskets and planters, and then to provide decorative Christmas displays in the run up to Christmas during November and December, the decorative Christmas displays typically comprising shaped structures which support light sources such as light bulbs. The expense and effort required to provide such spring, summer and winter displays is considerable, particularly as many of the displays are mounted to overhead locations, making installation potentially hazardous and disruptive for members of the public and to traffic. For the Christmas displays, there is the additional hazard of providing electricity for the light sources.

U.K. patent application no. 0409971 describes article mounting apparatus for mounting plant containers to lamp posts. Such article mounting apparatus requires a user to position a container on a bracket and then move the container to a locked position by a lateral movement of the container. In the locked position the container cannot easily be pushed upwardly off the bracket by, for example, vandals.

According to a first aspect of the present invention, there is provided a method of displaying decorative material, the method including the steps of:
a. providing a container defining an interior
b. locating a first seasonal decorative material in the interior
c. installing the container in a public place
d. after a first predefined time period, removing the first material and
e. locating a second seasonal decorative material in the interior.

At least one of the first or second decorative materials may be inanimate and the other may be inanimate, and may include animate plant material.

The method may include the steps of providing a first bracket, and installing the first bracket in a public place. The container may be mounted to the first bracket.

In one embodiment, the method may include the step of providing a first container and a second container, the first container including the first decorative material, and the second container including the second decorative material. The containers may be mountable to and demountable from the first bracket in sequence.

The inanimate decorative material may be in the form of a decorative item. The decorative item may include an electrical circuit and a structure, the electrical circuit being self contained and including accumulation means, a light source, and a solar power collector, the structure being arranged to support the light source, the item including a mounting for mounting to the container.

According to a second aspect of the present invention, there is provided a decorative item for mounting to a container, the item including an electrical circuit and a structure, the electrical circuit being self contained and including accumulation means, a light source, and a solar power collector, the structure being arranged to support the light source, the item including a mounting for mounting to the container.

Possibly, the decorative item is removably mountable to the container.

Possibly the mounting includes a base, which may be shaped, and may be shaped to correspond to the shape or a feature of the container, and may be shaped to correspond to an interior defined by the container.

The accumulation means may include a battery, which may be charged by the solar power connector.

The battery may locate in the base.

The solar power connector may include a solar panel, which may be supported by the structure.

The light source may be a light emitting diode (LED). The circuit may include a plurality of light sources.

The circuit may include a controller, which may control the operation of the light source or sources, and may control the charging of the accumulator means.

The structure may be in the form of a Christmas tree or other seasonal decorative item.

According to a third aspect of the present invention, there is provided a decorative assembly, the decorative assembly including a container, a decorative item mountable to the container, and a first bracket for mounting the container to a support, the decorative item being substantially as described in the preceding paragraphs.

Possibly the container is a plant container, and may be a self watering plant container.

Possibly the container includes a second bracket. Possibly the second bracket is mountable to the first bracket.

Possibly the first and second brackets are arranged to be mountable together to an engaged position by mutual relative movement of the first and second brackets in a first direction, and movable from the engaged position to a locked position by a mutual relevant movement of the first and second brackets in a second direction, the second direction being different to the first direction, the first and second brackets being arranged so that, in the locked position, mutual relative movement of the first and second brackets in a direction substantially opposite to the first direction is substantially prevented.

Possibly, the decorative assembly includes a pair of similar containers, a pair of similar decorative items each of which is mountable to one of the containers, and a pair of similar first brackets which are arrangeable to mount the containers to a common support.

The containers together may extend substantially completely around the support.

Embodiments of the present invention will now be described by way of example only, and with reference to the accompanying drawings, in which:—

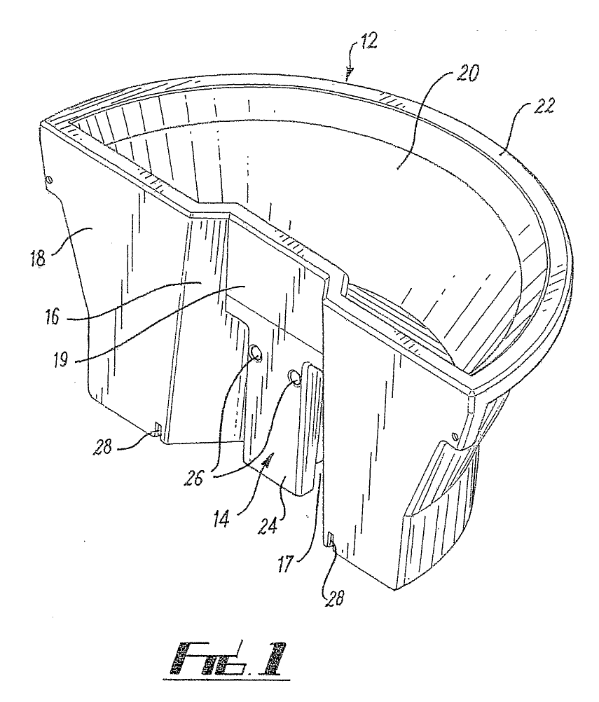

FIG. 1 is a perspective view of a known container;

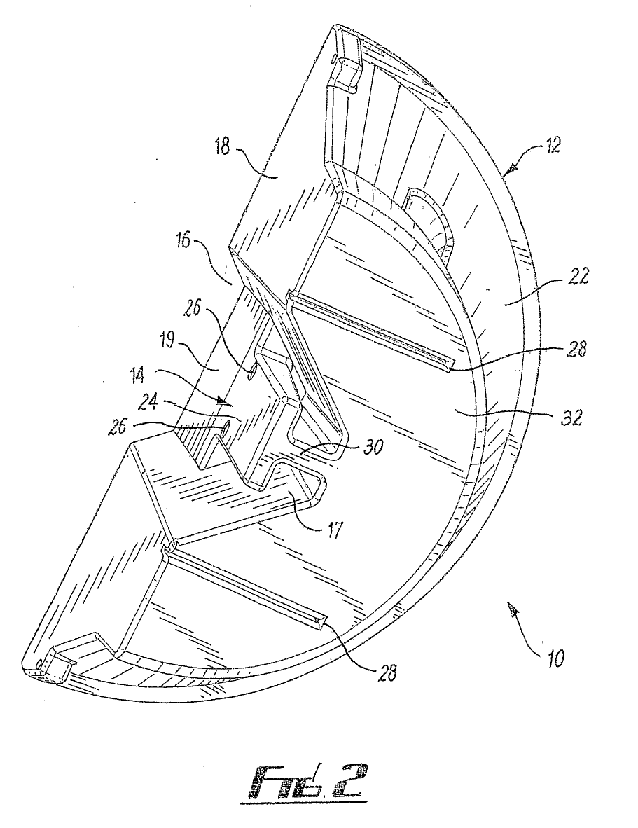

FIG. 2 is another perspective view of the container of FIG. 1;

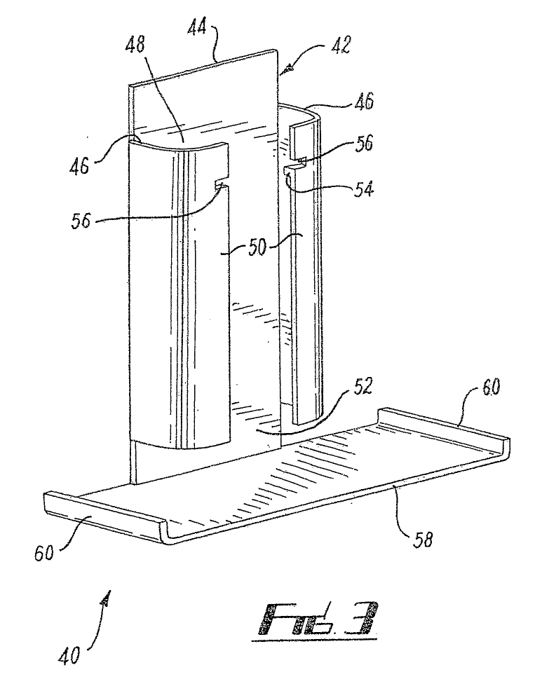

FIG. 3 is a perspective view of a known bracket;

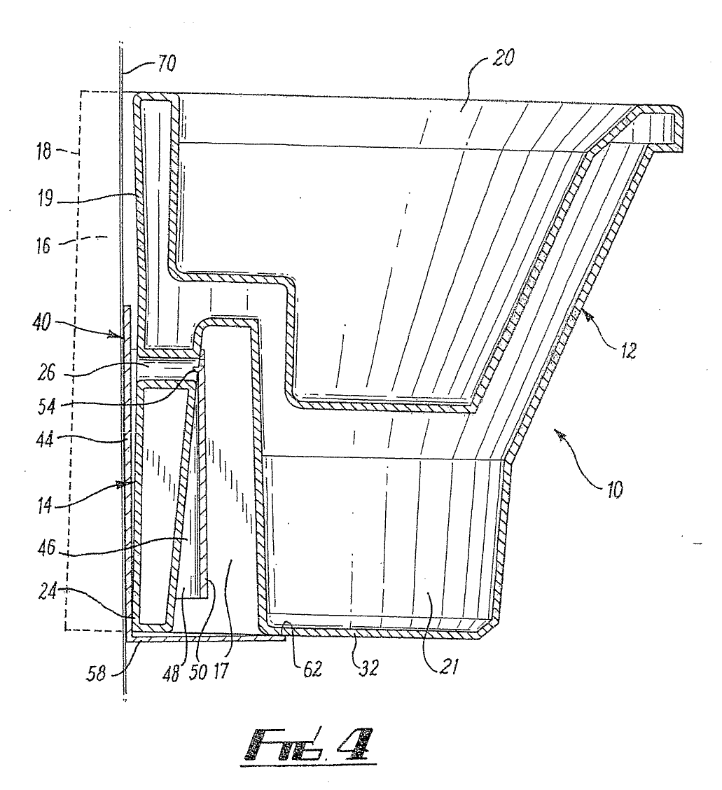

FIG. 4 is a sectional side view of the container of FIGS. 1 and 2 mounted to the bracket of FIG. 3;

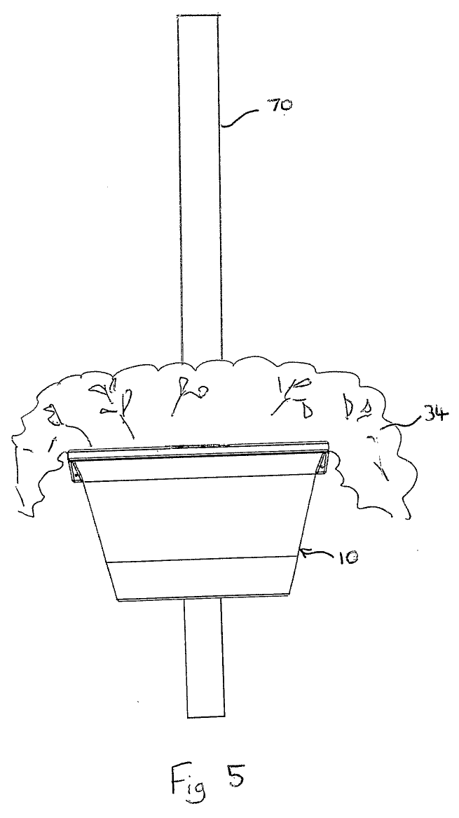

FIG. 5 is a front view of the container in use;

FIG. 6 is a schematic part sectional view of a decorative assembly in a partially disassembled condition;

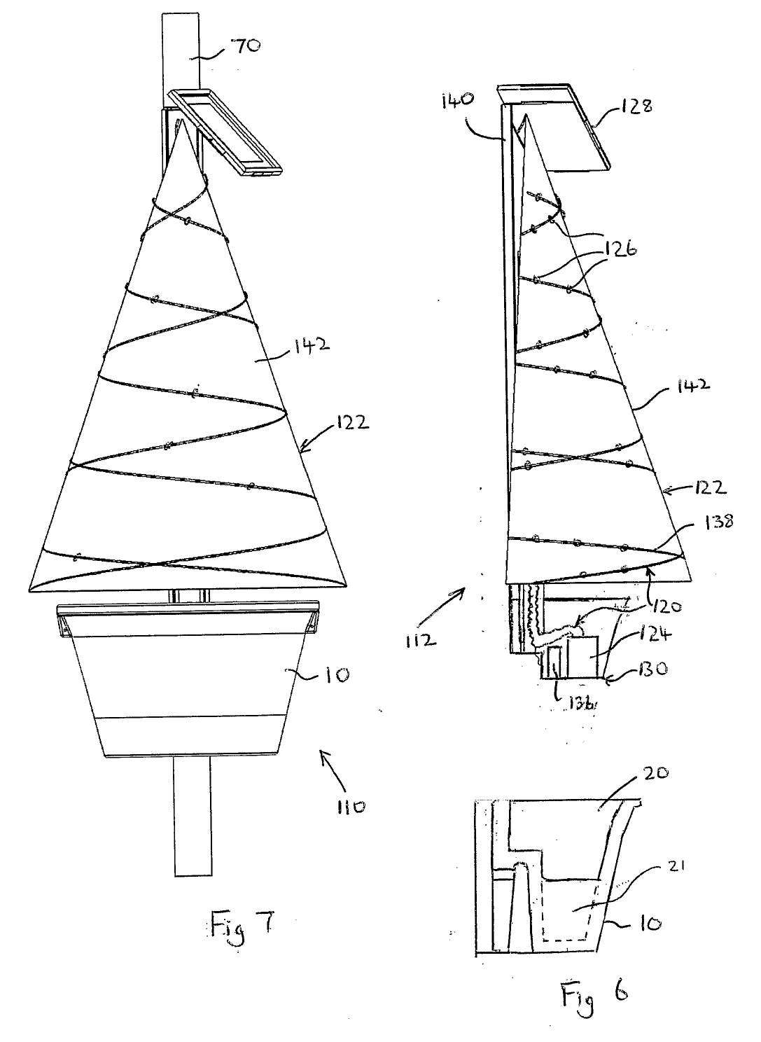

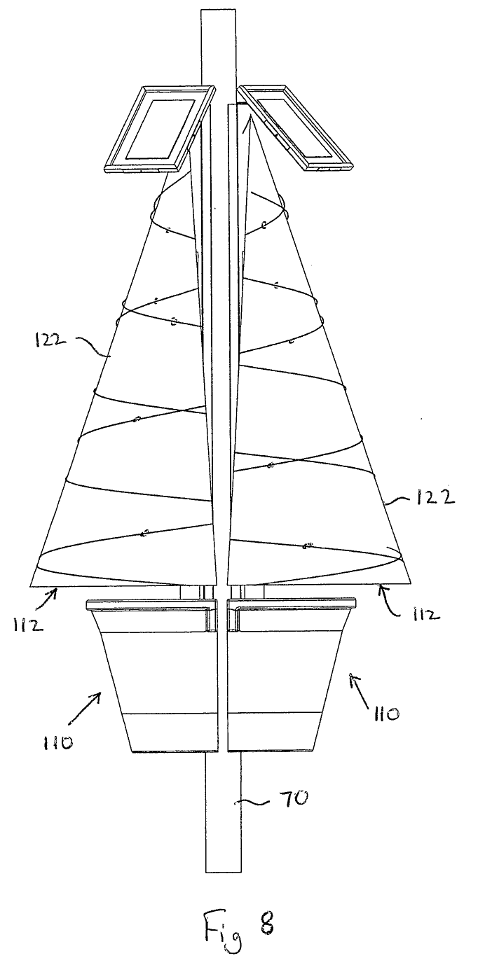

FIG. 7 is a front view of the decorative assembly in use; and

FIG. 8 is a side view of a pair of decorative assemblies in use.

FIGS. 1 to 4 show an example of known article mounting apparatus including a plant container 10 and a post bracket 40, which is the subject of the applicants U.K. patent application no. 0409971.9.

The plant container 10 includes a body 12. The body 12 includes a rear wall 18, a semi-circular front wall 22 and a base 32, which together define an interior 20. Each wall 18, 22, 32 is double skinned, defining an enclosed cavity therebetween, a lower part of which cavity forms a water reservoir 21. Such containers are commonly called “self watering containers”. Such containers include filling means in the form of a filling aperture (not shown) defined in the outer skin of the semi circular front wall 22 to allow filling and replenishment of the water in the water reservoir 21. In use, the interior 20 is filled with plant compost and plant material, and a capillary means such as capillary matting is provided between the water reservoir 21 and the interior 20 to allow the plants planted in the interior 20 to draw up water from the water reservoir 21.

The container 10 is formed of plastics material, and more particularly is formed of polyethylene, and is formed by rotational moulding.

The rear wall 18 includes a recess 16. The in use upper part of the recess 16 is relatively shallow having an upper recess rear wall 19. The lower part 17 of the recess 16 is deeper than the upper part, extending further into the container 10.

The container 10 includes a container bracket 14 which includes an engaging projection 24 extending downwardly from the upper recess rear wall 19 into the deeper recess 17. A web 30 extends from the engaging projection 24 to the rear wall 18 in the deeper recess 17. As shown most clearly in FIG. 2, the engaging projection 24 and the web 30 form a T shape when viewed from below.

As shown most clearly in FIGS. 2 and 4, the engaging projection tapers inwardly downwardly from the upper recess rear wall 19.

The engaging projection 24 defines a pair of parallel through passages 26 which extend from front to rear of the engaging projection 24 and are located in the upper part of the engaging projection 24.

The base 32 defines a pair of parallel channels 28 which extend from the rear wall 18 close to the recess 16, with one channel on either side of the recess 16. The channels 28 extend substantially across most of the width of the base 32.

FIG. 3 shows a post bracket 40 having a body 42, the body 42 including a mounting member 44 in the form of a generally rectangular planar plate. A pair of spaced, substantially parallel side members 46 extend forwardly from the plate 44. Each side member 46 includes a lip 50, each lip 50 extending inwardly towards the other lip 50 of the other side member 46. Together, the mounting member 44, the side members 46 and the lips 50 define a channel 48. A mouth 52 is defined between the lips 50.

Each lip 50 includes a locking projection in the form of a lug 54 which extends backwardly into the channel 48. The lugs 54 are located towards the upper end of the lips 50 in use.

A generally rectangular planar support member 58 extends substantially horizontally in use and forwardly from a lower edge of the mounting member 44. The support member 58 extends outwardly on either side of the mounting member 44. At each side edge of the support member 58, the support member 58 extends upwardly to form a rim 60.

The post bracket 40 is fabricated from steel. The lugs 54 are formed by cutting and bending of the lips 50, which forming process results in the formed apertures 56. After fabrication, the post bracket 40 is finished with a suitable protective coating.

FIG. 4 shows the apparatus in use. The post bracket 40 is mounted by conventional means to a ground engaging support member in the form of a lamppost 70, so that the plane of the mounting member 44 is substantially vertical, and the plane of the support member 58 is substantially horizontal. The plant container 10 is located over the post bracket 40 and moved in a substantially vertical downward direction so that the engaging projection 24 is received in the channel 48. Movement continues until the container 10 locates on the support member 58. In this position, the engaged position, the engaging projection 24 is engaged within the bracket 40 and the web 30 extends through the mouth 52, but the lugs 54 are not within the passages 26.

The container 10 is then pivoted about a pivot point 62 which is located on the support member 58. The container 10 pivots forwardly and downwardly so that the upper part of the engaging projection 24 moves forwardly within the channel 48 to a locked position in which the passages 26 receive the lugs 54, as shown in FIG. 4.

In the locked position, each lug 54 is received in the corresponding passage 26 so that if an attempt is made to move the container 10 vertically upwards to dislodge the container 10 from the post bracket 40, the location of the lugs 54 in the passages 26 prevents the upward movement.

The taper of the engaging projection 24 allows ease of manufacture, and also aids location of the engaging projection 24 in the channel 48. The engaging projection 24 is arranged to fit within the channel 48 so that only a relatively small pivotal movement of the container 10 is required to engage the lugs within the passages 26.

As the engaging projection 24 locates within the channel 48, the upturned rims 60 of the support member 58 locate in the channels 28 of the base 32 of the container 10.

FIG. 6 shows a decorative item 112 according to the invention. The decorative item 112 includes a structure 122 and a mounting including a base 130. The structure 122 includes an elongate structure member 140 which extends from the base 130 upwardly in use and supports a cover member 142. In the example shown in FIG. 6, the cover member is half conical in shape.

The decorative item 112 includes an electrical circuit 120, the electrical circuit 120 including accumulation means including a battery 124, a solar power collector in the form of a solar panel 128, a controller 136, a plurality of light sources in the form of light emitting diodes (LEDs) 126 and cabling 138 which extends between these aforesaid components. The base 130 is shaped to correspond to the interior 20 of the plant container 10. The LEDs 126 are supported by the cover member 142. The elongate structure member 140 supports the solar panel 128.

The semi-conical cover member 142 gives the appearance of a Christmas tree when viewed from the front as shown in FIG. 7.

The electrical circuit 120 is arranged to be self contained, the solar panel 128 charging the battery 124 by collecting solar power during daylight hours, the battery 124 storing the collected power. During night time hours, the battery 124 discharges, illuminating the LEDs 126. The controller 136 controls the charging of the battery 124 and the illumination of the LEDs 126. The controller 136 permits illumination of the LEDs 126 in accordance with the amount of stored power in the battery 124. When for example, the amount of stored charge in the battery falls below a predetermined level, the controller 136 could switch the LEDs 126 off. The controller 136 could include a timer and/or a clock and/or a calendar, to permit control according to particular days of the week, particular night time periods etc.

The controller 136 could include sensing means for sensing ambient light levels. The sensing means could include the solar panel 128. The controller 136 could be arranged to permit illumination of the LEDs 126 when a sensing signal from the solar panel 128 has a predetermined value. The controller 136 could be arranged to provide a discharge cycle when the battery 124 is fully charged, even if the lights are disconnected, thus ensuring that the battery life is maximised and the battery 124 is always ready for operation.

The controller 136 could be programmable, and could be programmable with a set of instructions. The set of instructions could include comparison instructions, in which the sensing signal is compared to a time signal provided by a clock, thus permitting the controller to distinguish temporary occurrences of abnormal lighting conditions, such as low light levels during a day time period and bright light levels such as from an adjacent lamp or car headlights during a night time period, and maintain the appropriate lighting condition in each case.

The invention provides a method of displaying decorative material as follows. The container 10 is filled with plant material 134 as shown in FIG. 5 and the container 10 mounted to the post bracket 40 as previously described, which could be mounted to a post 70 situated in a public place. The arrangement of the container bracket 14 and the post bracket 40 provides secure engagement of the container 10 to the post 70. In one example, the container could be provided with plant material 134 and mounted in position during the spring and summer months.

After a predefined time period, the container 10 is demounted from the post bracket 40 mounted to the post 70 as described previously and the plant material 34 removed from the container 10. The decorative item 112 is then mounted to the container 10 by locating the base 130 in the interior 20, the shape of the base 130 being a snug fit within the interior 20 so that the decorative item 112 is held securely within the interior 20 by the container 10. Additional mounting features could be provided such as clamping brackets. The relatively heavy battery 124 is located in the base 130 to enhance stability.

With the decorative item 112 in position in the container 10, the container 10 is then mounted to the post bracket 40 on the post 70 and the solar panel 128 adjusted to optimise the collection of solar power, for example by orientating the solar panel 128 towards the south. The decorative item 112, the container 10 and the post bracket 40 together form a decorative assembly 110.

The decorative assembly 110 could, for example, be mounted in position during the months of November and December in the run up to Christmas, and then demounted after Christmas. After Christmas, the decorative item 112 having a cover member 142 in the form of a semi-conical cover representing a Christmas tree could be replaced by another topical or seasonal structure. For example, in the period before Easter the structure could take the form of Easter eggs or an Easter bunny. With the advent of spring, the decorative item 112 could again be replaced by plant material 134 and so on.

In an alternative method, two containers 10 could be provided, with one container 10 being provided with plant material 134 and the other container 10 being provided with the decorative item 112, and these could be mounted in sequence to the post bracket 40 of the post 70, simplifying installation.

In another embodiment of the apparatus, suitable for use in the alternative method above, one of the two containers 10 could have a similar external appearance to the other container, but could have a different internal arrangement. Instead of having double skinned walls which define a water reservoir 21, the walls 18, 22, 32 could be single skinned, providing a larger interior 20 for receiving the base 130. The deeper interior 20 which could include the space 21 indicated by dotted lines in FIG. 6 provides greater stability and/or permits a larger base 130.

In a further embodiment of the invention, the containers could be of different sizes, shapes and appearance.

FIG. 8 shows an installation in which one post 70 supports a pair of opposed decorative assemblies 110 which are arranged so that together the decorative items 112 and the containers 10 extend substantially completely around the post 70, each decorative item 112 having a half conical structure 122, so that the representation of a Christmas tree is viewable from all directions.

Various other modifications may be made without departing from the scope of the invention. The structure of the decorative item could be of any suitable shape, form or size and formed of any suitable material. Any suitable light sources and power collector could be used, and any suitable accumulation means for storing power could be used. The decorative item could be mounted to any suitable container, and any suitable means of retaining the decorative item within the container could be used. The electrical circuit could include any suitable components.

There is thus provided a method of displaying decorative material which provides a number of advantages. The decorative item provides a self contained illuminated display, which requires no additional cabling. The decorative item is positioned within containers for which mountings have already been provided and therefore installation is simple and quick, minimising disruption and hazard risk. The same lifting equipment can be used for the containers. The containers are resistant to damage by vandals, and in particular are resistant to removal from the post bracket by unauthorised personnel. The invention thus allows users such as local authorities to provide a variety of seasonal displays which are attractive and yet are economic and cost effective. Since the locations of the post brackets 40 on the posts 70 remain the same throughout the year, the planning of maintenance is greatly simplified and therefore also more cost effective.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A decorative item for mounting to a container, the item including an electrical circuit and a structure, the electrical circuit being self contained and including accumulation means, a light source, and a solar power collector, the structure being arranged to support the light source, the item including a mounting for mounting to the container.

2. An item according to claim 1, in which the decorative item is removably mountable to the container.

3. An item according to claim 12 in which the mounting includes a base, which is shaped to correspond to the shape or a feature of the container.

4. (canceled)

5. An item according to claim 1, in which the accumulation means includes a battery, which is charged by the solar power collector.

6. (canceled)

7. An item according to claim 1, in which the solar power collector includes a solar panel, which is supported by the structure.

8. An item according to claim 1, in which the light source is a light emitting diode (LED).

9. (canceled)

10. An item according to claim 1, in which the accumulation means includes a battery, which is charged by the solar power collector, and the circuit includes a controller, which controls the operation of the light source or sources, and the charging of the accumulation means.

11. (canceled)

12. An item according to claim 1, in which the structure is in the form of a Christmas tree or other seasonal decorative item.

13. A decorative assembly, the decorative assembly including a container, a decorative item mountable to the container, and a first bracket for mounting the container to a support, the decorative item including an electrical circuit and a structure, the electrical circuit being self contained and including accumulation means, a light source, and a solar power collector, the structure being arranged to support the light source, the item including a mounting for mounting to the container.

14. An assembly according to claim 13, in which the container is a plant container.

15. An assembly according to claim 13, in which the container includes a second bracket which is mountable to the first bracket.

16. An assembly according to claim 13, in which the the container includes a second bracket which is mountable to the first bracket, and the first and second brackets are arranged to be mountable together to an engaged position by mutual relative movement of the first and second brackets in a first direction, and movable from the engaged position to a locked position by a mutual relevant movement of the first and second brackets in a second direction, the second direction being different to the first direction, the first and second brackets being arranged so that, in the locked position, mutual relative movement of the first and second brackets in a direction substantially opposite to the first direction is substantially prevented.

17. An assembly according to claim 13, in which the decorative assembly includes a pair of similar containers, a pair of similar decorative items each of which is mountable to one of the containers, and a pair of similar first brackets which are arrangeable to mount the containers to a common support.

18. An item according to claim 13, in which the decorative assembly includes a pair of similar containers, a pair of similar decorative items each of which is mountable to one of the containers, and a pair of similar first brackets which are arrangeable to mount the containers to a common support, and the containers together extend substantially completely around the support.

19. A method of displaying decorative material, the method including the steps of:
a. providing a container defining an interior
b. locating a first seasonal decorative material in the interior
c. installing the container in a public place
d. after a first predefined time period, removing the first material and
e. locating a second seasonal decorative material in the interior.

20-21. (canceled)

22. A method according to claim 19, in which the container is a plant container, at least one of the first or second materials is inanimate, and the other includes animate plant material.

23. A method according according to claim 19, in which the method includes the steps of providing a first bracket, installing the first bracket in a public place and mounting the container to the first bracket.

24. A method according to claim 19, in which the method includes the steps of providing a first bracket, installing the first bracket in a public place and mounting the container to the first bracket, and the method includes the step of providing a first container and a second container, the first container including the first decorative material and the second container including the second decorative material, the containers being mountable to and demountable from the first bracket in sequence.

25. (canceled)

26. A method according to claim 19, in which the container is a plant container, at least one of the first or second materials is inanimate, and the other includes animate plant material, and the inanimate decorative material is in the form of a decorative item, and the decorative item includes an electrical circuit and a structure, the electrical circuit being self contained and including accumulation means, a light source, and a solar power collector, the structure being arranged to support the light source, the item including a mounting for mounting to the container.

27-31. (canceled)
